(19) United States
(12) Patent Application Publication
(10) Pub. No.: US 2024/0162780 A1
(43) Pub. Date: May 16, 2024

(54) FLUID MACHINE

(71) Applicant: KABUSHIKI KAISHA TOYOTA JIDOSHOKKI, Kariya-shi, Aichi (JP)

(72) Inventors: Shuto ONITSUKA, Kariya-shi, Aichi (JP); Akihiro MURANISHI, Kariya-shi, Aichi (JP); Yosuke INAGAKI, Kariya-shi, Aichi (JP); Satoru SHIMADA, Kariya-shi, Aichi (JP)

(73) Assignee: KABUSHIKI KAISHA TOYOTA JIDOSHOKKI, Kariya-shi, Aichi (JP)

(21) Appl. No.: 18/282,186

(22) PCT Filed: Feb. 24, 2022
(86) PCT No.: PCT/JP2022/007713

§ 371 Date: Sep. 14, 2023

(30) Foreign Application Priority Data
Mar. 18, 2021 (JP) 2021-044798

(51) Int. Cl. H02K 5/24; F04B 35/04; F04C 18/02; H02K 11/33

(52) U.S. Cl. CPC H02K 5/24; F04B 35/04; F04C 18/0207; H02K 11/33; F04C 2240/30; F04C 2240/40; F04C 2240/805

(57) ABSTRACT

A fluid machine includes an electric motor, an inverter, a housing, a cover member that is fixed to the housing and defines an accommodation chamber, a sealing member that is disposed between the cover member and the housing, and a fastening member that is fastened to the housing. The housing has an insertion hole. The fastening member has a shank inserted into the insertion hole, a flange applying a fastening force to the cover member through a rubber washer, and a positioning portion defining positions of the shank and the flange relative to the housing. The cover member is supported on the housing. Stiffness of the rubber washer is greater than stiffness of the sealing member.

### TECHNICAL FIELD

The present invention relates to a fluid machine.

### BACKGROUND ART

A fluid machine disclosed in Patent Document 1 includes an electric motor, a compression part, an inverter, a housing, and a cover member. The electric motor drives the compression part. The inverter is configured to convert a DC power to an AC power and supplies the AC power to the electric motor. The housing accommodates the electric motor and the compression part. The cover member is attached to the housing. An accommodation chamber is defined between the cover member and the housing. The inverter is accommodated in the accommodation chamber.

### CITATION LIST

### Patent Document

Patent Document 1: Japanese Patent Application Publication No. 2020-002947

### SUMMARY OF INVENTION

### Technical Problem

The driving of the electric motor causes the housing to vibrate. Here, when the cover member and the housing are in contact with each other, the vibrations of the housing are transmitted to the cover member. As a result, the cover member vibrates, which causes noise.

### Solution to Problem

A fluid machine to solve the above problem includes an electric motor, an inverter configured to drive the electric motor, a housing in which the electric motor is accommodated, a cover member that is fixed to the housing and defines an accommodation chamber in which the inverter is accommodated, a sealing member that is disposed between the cover member and the housing and makes a seal for the accommodation chamber, and a fastening member that extends through the cover member and is fastened to the housing to fix the cover member to the housing. The housing has an insertion hole. The fastening member has a shank inserted into the insertion hole, a flange applying a fastening force to the cover member through a rubber washer, and a positioning portion that is in contact with the housing to define positions of the shank and the flange relative to the housing. The cover member is supported on the housing such that the cover member is held between the rubber washer and the sealing member that are elastically deformed. Stiffness of the rubber washer is greater than stiffness of the sealing member.

The sealing member and the rubber washer each serve as a vibration absorbing material, thereby suppressing transmission of vibrations from the housing to the cover member. A force per unit area that is applied from the fastening member to the rubber washer is larger than a force per unit area that is applied from the fastening member to the sealing member. When the stiffness of the rubber washer is made greater than the stiffness of the sealing member, a compressive deformation amount of the rubber washer is made smaller than that in a case where the stiffness of the rubber washer is the stiffness of the sealing member or less. As a result, a compressive deformation amount of the sealing member is secured. The sealing member and the rubber washer suppress the transmission of the vibrations of the housing to the cover member, thereby reducing noise. The compressive deformation amount of the sealing member is secured, thereby preventing the sealing performance between the housing and the cover member from decreasing.

According to the above-described fluid machine, the following configuration may be employed. The fastening member has a bolt and a collar into which the bolt is inserted. The bolt has the shank and an external thread portion screwed into the insertion hole. The collar has the positioning portion and the flange.

According to the above-described fluid machine, the following configuration may be employed. The fastening member is a shoulder bolt. The shoulder bolt has a head, the shank, an external thread portion screwed into the insertion hole, and a cylindrical portion that is disposed between the head and the shank and has a diameter larger than that of the shank. The head corresponds to the flange. The cylindrical portion corresponds to the positioning portion.

According to the above-described fluid machine, the following configuration may be employed. The cover member has a surrounding portion that surrounds at least a part of the rubber washer in a radial direction of the rubber washer.

According to the above-described fluid machine, the following configuration may be employed. In a compressive deformation amount of the sealing member, a change amount of a load of the sealing member relative to a change amount of the compressive deformation amount is changed at a point. The change amount of the load relative to the change amount of the compressive deformation amount in a case where the compressive deformation amount of the sealing member is a compressive deformation amount at the point or more is larger than the change amount of the load relative to the change amount of the compressive deformation amount in a case where the compressive deformation amount of the sealing member is less than the compressive deformation amount at the point. The compressive deformation amount of the sealing member is the compressive deformation amount at the point or more.

### Advantageous Effect of Invention

According to the present invention, it is possible to reduce the noise.

### BRIEF DESCRIPTION OF DRAWINGS

FIG. 1 is a cross-sectional view of a fluid machine according to an embodiment of the present invention.

FIG. 2 is an exploded perspective view illustrating the fluid machine.

FIG. 3 is a cross-sectional view of a sealing member that is not squeezed according to the embodiment.

FIG. 4 is an enlarged cross-sectional view illustrating a fastening member according to the embodiment.

FIG. 5 is a graph showing a relationship between a compressive deformation amount of the sealing member and a load of the sealing member according to the embodiment.

FIG. 6 is a graph showing a relationship between a compressive deformation amount of rubber washers and a load of the rubber washers according to the embodiment.

FIG. 7 is a graph for explaining a proportion of the compressive deformation amount of the sealing member in a sum of the compressive deformation amount of the sealing member and the compressive deformation amount of the rubber washers and a proportion of the compressive deformation amount of the rubber washers in the sum of the compressive deformation amount of the sealing member and the compressive deformation amount of the rubber washers.

FIG. 8 is an enlarged cross-sectional view illustrating a shoulder bolt according to a modification.

### DESCRIPTION OF EMBODIMENTS

The following will describe an embodiment of a fluid machine according to the present invention.

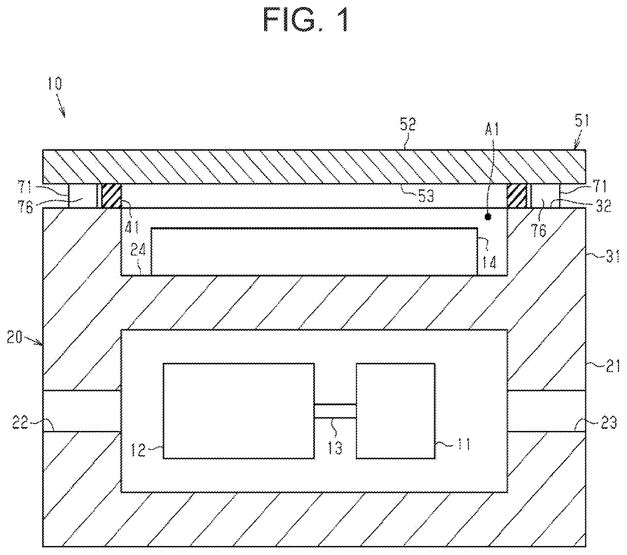

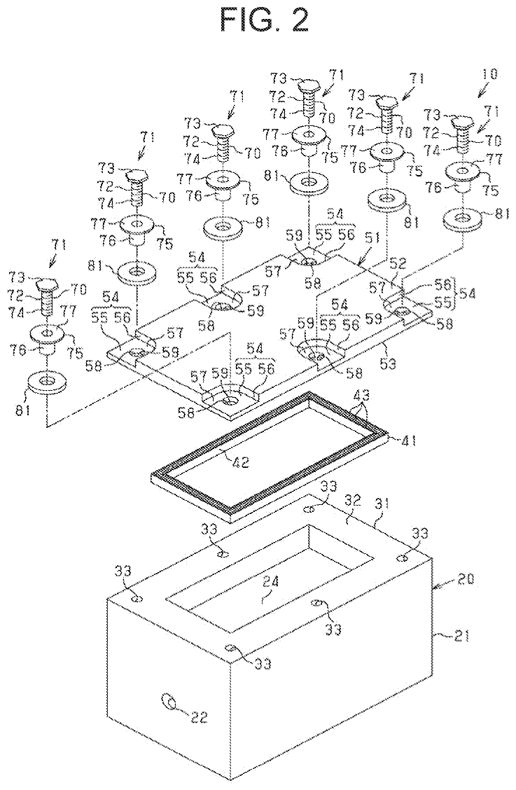

As illustrated in FIGS. 1 and 2, a fluid machine 10 includes a compression part 11, an electric motor 12, a rotary shaft 13, an inverter 14, a housing 20, a sealing member 41, a cover member 51, fastening members 71, and rubber washers 81. The compression part 11 is configured to compress fluid. Examples of the compression part 11 include a scroll type compression part, a vane type compression part, and a piston type compression part. The electric motor 12 rotates the rotary shaft 13. The rotation of the rotary shaft 13 drives the compression part 11. The inverter 14 is configured to convert a DC power to an AC power and supplies the AC power to the electric motor 12. Thus, the inverter 14 drives the electric motor 12.

As illustrated in FIG. 1, the housing 20 includes an accommodation portion 21 and a partition wall 31. The housing 20 is made of metal. The housing 20 is, for example, made of aluminum alloy.

The accommodation portion 21 is formed in a box-shape. The accommodation portion 21 accommodates the electric motor 12, the rotary shaft 13, and the compression part 11. A length of the accommodation portion 21 in an axial direction of the rotary shaft 13 is longer than that of the accommodation portion 21 in a direction perpendicular to the axial direction of the rotary shaft 13. In detail, the longest length of the accommodation portion 21 in the axial direction of the rotary shaft 13 is longer than the longest length of the accommodation portion 21 in the direction perpendicular to the axial direction of the rotary shaft 13. The accommodation portion 21 has a suction port 22 and a discharge port 23. When the compression part 11 is driven, fluid is sucked into the accommodation portion 21 through the suction port 22. The sucked fluid is compressed by the compression part 11 and discharged from the discharge port 23. The fluid machine 10 of the present embodiment corresponds to an electric compressor by which fluid is sucked, compressed, and discharged.

As illustrated in FIG. 2, the partition wall 31 protrudes from an outer surface 24, which is one of outer surfaces of the accommodation portion 21. In the present embodiment, the partition wall 31 is formed on the outer surface 24, which is the one of the outer surfaces of the accommodation portion 21 located in the direction perpendicular to the axial direction of the rotary shaft 13. The partition wall 31 is formed in a ring shape. The partition wall 31 is formed along a peripheral edge of the outer surface 24. The partition wall 31 has an outer surface 32. The outer surface 32 is an end surface that is located at an end of the partition wall 31 protruding from the outer surface 24. The partition wall 31 includes a plurality of insertion holes 33. The insertion holes 33 are circular holes and open on the outer surface 32. In the present embodiment, the insertion holes 33 correspond to screw holes with internal thread grooves.

The sealing member 41 is formed in a ring shape. The sealing member 41 is formed along a shape of the outer surface 32 of the partition wall 31. The sealing member 41 is made of rubber. In the present embodiment, the sealing member 41 is made of silicon rubber.

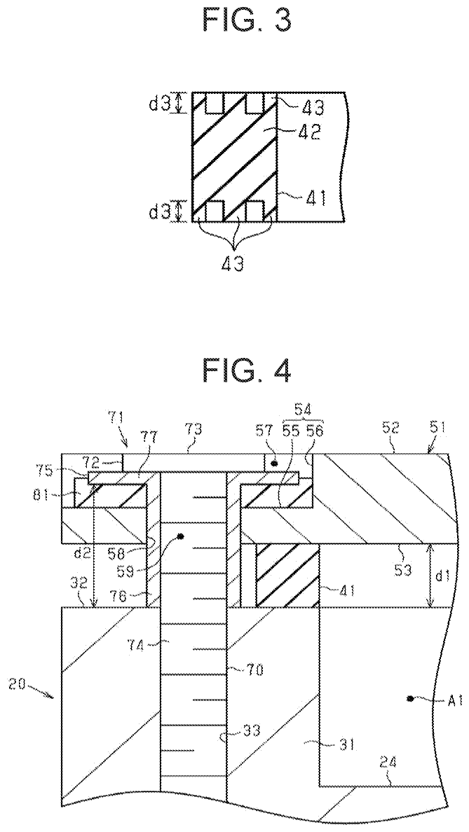

As illustrated in FIGS. 2 and 3, the sealing member 41 when it is not squeezed includes a main body 42 and protruding portions 43. The main body 42 is formed in a ring shape. The main body 42 is made of a solid material. The main body 42 may be formed in a rectangular shape when seen in a sectional view. The protruding portions 43 are each formed in a ring shape. The protruding portions 43 protrude from the main body 42 in an axial direction of the sealing member 41 (a direction facing the cover member 51 and a direction facing the partition wall 31). A plurality of protruding portions 43 are arranged between an inner edge and an outer edge of the main body 42. In the present embodiment, the protruding portions 43 protrude from the main body 42 on opposite sides in the axial direction of the sealing member 41. For convenience of explanation, the sealing member 41 that is not squeezed is illustrated in FIG. 2.

As illustrated in FIG. 2, the cover member 51 is formed in a plate shape. The cover member 51 has a first surface 52 and a second surface 53. The first surface 52 and the second surface 53 are located opposite to each other in a thickness direction of the cover member 51. The cover member 51 has a plurality of defining surfaces 54 and a plurality of through hole defining surfaces 58. The plurality of defining surfaces 54 are arranged with a distance from each other along a peripheral edge of the cover member 51. Each of the defining surfaces 54 includes a first defining surface 55 and a second defining surface 56. The first defining surface 55 is a surface extending in parallel with the first surface 52. The first defining surface 55 is located between the first surface 52 and the second surface 53 in the thickness direction of the cover member 51. The second defining surface 56 extends from the first surface 52 to the first defining surface 55. The second defining surface 56 is a curved surface. The second defining surface 56 is continuous with the peripheral edge of the cover member 51. That is, the second defining surface 56 is discontinuous at the peripheral edge of the cover member 51. The defining surfaces 54 define recess portions 57 which are recessed from the first surface 52 in the thickness direction of the cover member 51, respectively. The recess portions 57 open at the peripheral edge of the cover member 51.

The through hole defining surfaces 58 are each formed in the corresponding defining surface 54. Each distance between the plurality of through hole defining surfaces 58 coincides with the corresponding distance between the insertion holes 33. The word of “coincide” in the present embodiment means that a slight error caused by a tolerance is allowed. The through hole defining surfaces 58 are surfaces each extending from the first defining surface 55 to the second surface 53. The through hole defining surfaces 58 define through holes 59, respectively. The through holes 59 are holes extending through the cover member 51.

The fastening members 71 each include a bolt 72 and a collar 75.

The bolt 72 has a head 73, a shank 70, an external thread portion 74. The external thread portion 74 is a protruding portion formed in a spiral shape and defines an external thread groove. The external thread portion 74 is formed on an outer peripheral surface of the shank 70. The external thread portion 74 may be formed on the shank 70 all over the length of the shank 70 or may be partly formed on the shank 70.

The bolt 72 is inserted into the collar 75. The collar 75 has a positioning portion 76 and a flange 77. The positioning portion 76 is formed in a cylindrical shape. An inner diameter of the positioning portion 76 is longer than a diameter of the shank 70. An outer diameter of the positioning portion 76 is longer than a diameter of each of the insertion holes 33. A length of the positioning portion 76 in an axial direction of the positioning portion 76 is shorter than that of the shank 70 in an axial direction of the shank 70. The flange 77 is disposed at one end of opposite ends of the positioning portion 76 in the axial direction of the positioning portion 76. The flange 77 extends in a radial direction of the positioning portion 76 from the positioning portion 76. In the present embodiment, the flange 77 is formed in a circular ring shape.

The rubber washers 81 are each formed in a circular ring shape. An inner diameter of each of the rubber washers 81 is longer than the outer diameter of the positioning portion 76. The rubber washers 81 are made of rubber. Stiffness of the rubber washers 81 is greater than that of the sealing member 41. The stiffness is an index that indicates a degree of deformation for a constant force. As the stiffness becomes greater, an amount of deformation for the constant force becomes smaller. Different materials are used for the rubber washers 81 and the sealing member 41, thereby making the stiffness of the rubber washers 81 greater than that of the sealing member 41. For example, the rubber washers 81 are made of a material with a higher Young's modulus than that of a material of the sealing member 41, so that the stiffness of the rubber washers 81 becomes greater than the stiffness of the sealing member 41. In the present embodiment, the rubber washers 81 are made of nitrile rubber. For convenience of explanation, the rubber washers 81 that are not squeezed are illustrated in FIG. 2.

As illustrated in FIG. 4, the cover member 51 is fixed to the housing 20 by the fastening members 71. The cover member 51 is fixed with the second surface 53 facing the outer surface 24 of the accommodation portion 21. The sealing member 41 is disposed between the cover member 51 and the outer surface 32 of the partition wall 31. A space enclosed by the accommodation portion 21, the partition wall 31, and the cover member 51 corresponds to an accommodation chamber A1. The cover member 51 defines the accommodation chamber A1. The inverter 14 is accommodated in the accommodation chamber A1.

The shank 70 is inserted into the positioning portion 76 such that the head 73 and the flange 77 face each other. The positioning portion 76 and the shank 70 are inserted into the corresponding rubber washer 81. The positioning portion 76 and the shank 70 extend through the corresponding through hole 59. The positioning portion 76 is in contact with the outer surface 32 of the partition wall 31. More specifically, one end surface of the positioning portion 76 in the axial direction thereof is in contact with the outer surface 32 of the partition wall 31. In the present embodiment, the shank 70 is inserted through the corresponding insertion hole 33. The word of “insert” means that something is inserted through a hole. In the present embodiment, the shank 70 is inserted through the corresponding insertion hole 33. The word of “through” does not need to mean that something extends through a hole. At least a part of the shank 70 only needs to be located in the corresponding insertion hole 33. In the present embodiment, the external thread portion 74 is screwed into the corresponding insertion hole 33. As a result, the bolt 72 is fastened to the housing 20. The word of “screw” means that two members are fixed by fitting an external thread portion of the one member into an internal thread portion of the other member. In the present embodiment, the bolt 72 is fixed to the housing 20 by fitting the external thread portion 74 to an internal thread portion formed on the corresponding insertion hole 33. The rubber washers 81 are each located between the flange 77 and the first defining surface 55. The head 73, the flange 77, and the corresponding rubber washer 81 are accommodated in the corresponding recess portion 57. The head 73, the flange 77, and the corresponding rubber washer 81 are located between the first surface 52 and the first defining surface 55 in the thickness direction of the cover member 51. That is, the head 73 does not protrude outward from the first surface 52 of the cover member 51. A part of each of the rubber washers 81 is surrounded in a radial direction of the rubber washer 81 by the corresponding second defining surface 56. The second defining surface 56 corresponds to a surrounding portion in the present invention.

The external thread portion 74 is screwed to the corresponding insertion hole 33, which applies a fastening force of the corresponding bolt 72 to the corresponding rubber washer 81 through the flange 77. The fastening force of the bolt 72 is applied to the cover member 51 through the rubber washer 81. Thus, a force toward the housing 20 is applied to the cover member 51. This means that the flange 77 applies the force toward the housing 20 to the cover member 51 through the rubber washer 81. The rubber washer 81 is elastically deformed by the fastening force of the bolt 72 to be squeezed. The sealing member 41 is elastically deformed by a force applied from the cover member 51 to be squeezed. That is, the sealing member 41 and the rubber washers 81 receive the fastening force of the bolts 72 to be squeezed. The cover member 51 is supported on the housing 20 such that the cover member 51 is held between the rubber washers 81 and the sealing member 41, which are elastically deformed.

The force transmitted from the cover member 51 to the sealing member 41 increases as a distance d1 between the cover member 51 and the outer surface 32 of the partition wall 31 is shortened. The distance d1 is a length between the second surface 53 of the cover member 51 and the outer surface 32 of the partition wall 31. In the present embodiment, the distance d1 between the cover member 51 and the outer surface 32 of the partition wall 31 is defined by the fastening members 71, thereby defining a compressive deformation amount of the sealing member 41. As the external thread portion 74 is screwed into the corresponding insertion hole 33 by rotating the bolt 72, a distance between the head 73 and the outer surface 32 of the partition wall 31 is shortened. When the positioning portion 76 is in contact with the outer surface 32 of the partition wall 31, the positioning portion 76 receives the fastening force of the bolt 72. The wording of “in contact with” means being brought into contact and being in contact. In the present embodiment, the positioning portion 76 is brought into contact with the partition wall 31 by rotating the bolt 72, so that the positioning portion 76 is in contact with the partition wall 31. The positioning portion 76 is in contact with the outer surface 32 of the partition wall 31, which defines positions of the shank 70 and the flange 77 relative to the housing 20. As a result, the distance d1 between the cover member 51 and the outer surface 32 of the partition wall 31 is defined. In detail, a length of a portion of the positioning portion 76 in the axial direction thereof, which protrudes outside the corresponding through hole 59, corresponds to the distance d1 between the cover member 51 and the outer surface 32 of the partition wall 31. The distance d1 between the cover member 51 and the outer surface 32 of the partition wall 31 is adjusted by adjusting the length of the positioning portion 76 in the axial direction thereof, which makes the compressive deformation amount of the sealing member 41 adjustable. A distance d2 between the flange 77 and the outer surface 32 of the partition wall 31 is defined by the length of the positioning portion 76 in the axial direction thereof. The distance d2 is a length between the outer surface 32 of the partition wall 31 and a surface that is in contact with the corresponding rubber washer 81, of opposite surfaces of the flange 77, in the axial direction of the positioning portion 76. The sum of the compressive deformation amount of the sealing member 41 and a compressive deformation amount of the rubber washer 81 is defined by the distance d2. The sum of the compressive deformation amount of the sealing member 41 and the compressive deformation amount of the rubber washer 81 is also adjustable by adjusting the length of the positioning portion 76 in the axial direction thereof. The sum of the compressive deformation amount of the sealing member 41 and the compressive deformation amount of the rubber washer 81 is referred to as a sum of compressive deformation amounts as appropriate.

In the present embodiment, the compressive deformation amount of the sealing member 41 is equal to or more than a length of each of the protruding portions 43 that protrude from the main body 42 when the sealing member 41 is not squeezed. Hereinafter, the length of each of the protruding portions 43 that protrude from the main body 42 is referred to as a protruding length of the protruding portion 43. In a case where the protruding portions 43 protrude from the main body 42 on the opposite sides in the axial direction of the sealing member 41, the protruding length of the protruding portion 43 corresponds to a sum of amounts of protrusion in the protruding portions 43 that protrude from the main body 42 on the opposite sides. For example, as illustrated in FIG. 3, amounts of protrusion d3 in the protruding portions 43 that protrude from the main body 42 on the opposite sides in the axial direction of the sealing member 41 are the same. In this case, the protruding length of the protruding portion 43 is twice the amount of protrusion d3. In a case where the protruding portions 43 protrude from the main body 42 on one side in the axial direction of the sealing member 41, the protruding length of the protruding portion 43 corresponds to the amount of protrusion d3.

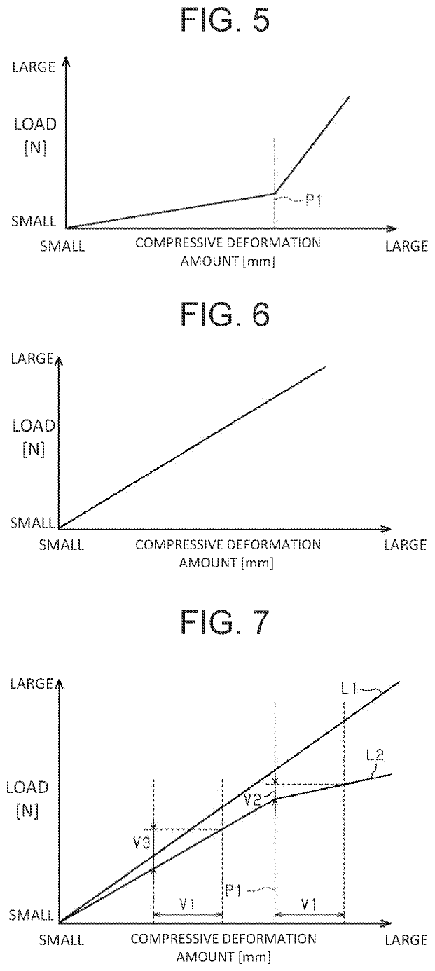

As illustrated in FIG. 5, as the compressive deformation amount of the sealing member 41 increases, a load of the sealing member 41 increases. The load of the sealing member 41 corresponds to a resilient force of the sealing member 41 generated by squeezing the sealing member 41. In the compressive deformation amount of the sealing member 41, a change amount of the load of the sealing member 41 relative to a change amount of the compressive deformation amount of the sealing member 41 is changed at a point P1. The change amount of the load relative to the change amount of the compressive deformation amount in a case where the compressive deformation amount of the sealing member 41 is a compressive deformation amount at the point P1 or more is larger than that in a case where the compressive deformation amount of the sealing member 41 is less than the compressive deformation amount at the point P1. The compressive deformation amount at the point P1 coincides with the protruding length of the protruding portion 43. When the sealing member 41 is squeezed, the protruding portions 43 are firstly squeezed. At this time, the load of the sealing member 41 is less likely to be increased due to spaces between the adjacent protruding portions 43. For that reason, the change amount of the load relative to the change amount of the compressive deformation amount is small until the spaces are filled with the squeezed protruding portions 43. When the spaces are filled with the squeezed protruding portions 43, the main body 42 starts to be squeezed. The main body 42 is made of the solid material, and thus, the change amount of the load is larger relative to the change amount of the compressive deformation amount. As the load of the sealing member 41 increases, the sealing member 41 is less likely to be squeezed. That is, the change amount of the compressive deformation amount of the sealing member 41 relative to a change amount of the fastening force of the bolt 72 in the case where the compressive deformation amount of the sealing member 41 is the compressive deformation amount at the point P1 or more becomes smaller than that in the case where the compressive deformation amount of the sealing member 41 is less than the compressive deformation amount at the point P1. As described above, the compressive deformation amount of the sealing member 41 is designed such that the compressive deformation amount of the sealing member 41 is the protruding length of the protruding portion 43 or more. This means that the compressive deformation amount of the sealing member 41 in the present embodiment is the compressive deformation amount at the point P1 or more.

The following will describe operations of the present embodiment.

The compression part 11 is driven by the electric motor 12 to cause the housing 20 to vibrate. The outer surface 32 of the partition wall 31 and the cover member 51 are distant from each other. As a result, even when the housing 20 vibrates by the driving of the electric motor 12, these vibrations are hardly transmitted to the cover member 51. The transmission of the vibrations from the housing 20 to the cover member 51 through the sealing member 41 is suppressed by the sealing member 41. When the housing 20 vibrates, these vibrations are transmitted to the fastening members 71. The transmission of the vibrations from the housing 20 into the cover member 51 through the fastening members 71 is suppressed by the rubber washers 81, which are provided between the respective flanges 77 and the cover member 51. The sealing member 41 and the rubber washers 81 each serve as a vibration absorbing material, thereby suppressing the transmission of the vibrations to the cover member 51.

Regarding an area of a surface on which the fastening force of the bolts 72 is applied, a sum of areas in the rubber washers 81 is smaller than an area in the sealing member 41. The surfaces on which the fastening force of the bolts 72 is applied correspond to surfaces of the sealing member 41 and the rubber washers 81 when the sealing member 41 and the rubber washers 81 are each seen in the axial direction of the shank 70. The rubber washers 81 are each locally provided, whereas the sealing member 41 is formed in the ring shape along the shape of the outer surface 32 of the partition wall 31. This causes a difference in area of the surface on which the fastening force of the bolts 72 is applied between the sealing member 41 and the rubber washers 81. Due to the difference in area, a force per unit area that is applied from the fastening members 71 to the rubber washers 81 is larger than a force per unit area that is applied from the fastening members 71 to the sealing member 41. The sum of the compressive deformation amount of the sealing member 41 and the compressive deformation amount of the rubber washers 81 is defined by the distance d2. Accordingly, the compressive deformation amount of the sealing member 41 decreases as the compressive deformation amount of the rubber washers 81 increases. The small compressive deformation amount of the sealing member 41 may make a sealing performance between the housing 20 and the cover member 51 lower. When the stiffness of the rubber washers 81 is made greater than the stiffness of the sealing member 41, the compressive deformation amount of the rubber washers 81 is made smaller than that in a case where the stiffness of the rubber washers 81 is the stiffness of the sealing member 41 or less. As a result, the compressive deformation amount of the sealing member 41 is secured.

In the present embodiment, the length of the positioning portion 76 in the axial direction thereof is adjusted such that the compressive deformation amount of the sealing member 41 is the protruding length of the protruding portion 43 or more. As described above, the compressive deformation amount of the sealing member 41 is the compressive deformation amount at the point P1 or more.

As illustrated in FIG. 6, as the compressive deformation amount of the rubber washers 81 increases, the load of the rubber washers 81 increases. In the rubber washers 81, the change amount of the load is constant relative to the change amount of the compressive deformation amount. In order to make it easier to understand characteristics of the sealing member 41 and the rubber washers 81, the load is shown so as to be changed linearly relative to the compressive deformation amount in FIGS. 5 and 6. Actually, a contact area with the sealing member 41 or the rubber washers 81 and the cover member 51 and a contact area with the sealing member 41 or the rubber washers 81 and the housing 20 are increased as the compressive deformation amount increases, so that the load may not be changed linearly relative to the compressive deformation amount.

A horizontal axis in FIG. 7 shows a sum of the compressive deformation amounts. A vertical axis in FIG. 7 shows a sum of compressive deformation amounts or the compressive deformation amount of the sealing member 41. A line L1 represents the sum of the compressive deformation amounts. That is, a value in the horizontal axis is equal to a value in the vertical axis on the line L1. A line L2 represents a change of a compressive deformation amount of the sealing member 41 relative to the sum of the compressive deformation amounts.

Accordingly, a difference between the value on the line L2 in the vertical axis and the value on the line L1 in the vertical axis shows the compressive deformation amount of the rubber washers 81. For that reason, a ratio of the difference between the value on the line L2 in the vertical axis and the value on the line L1 to the value on the line L1 in the vertical axis shows a ratio of the compressive deformation amount of the rubber washers 81 to the compressive deformation amount of the sealing member 41.

The sealing member 41 is less likely to be squeezed over the point P1. Thus, the proportion of the compressive deformation amount of the sealing member 41 in the sum of the compressive deformation amounts decreases over the point P1. On the other hand, the proportion of the compressive deformation amount of the rubber washers 81 in the sum of the compressive deformation amounts increases over the point P1.

Although the sum of the compressive deformation amounts is defined by the fastening members 71, the sum of the compressive deformation amounts varies. This variation is caused by an accumulation of a tolerance of a thickness of each of the rubber washers 81, a tolerance of a thickness of the cover member 51, a tolerance of a thickness of the sealing member 41, and a tolerance of a length of the positioning portion 76 in the axial direction thereof. In the case when the compressive deformation amount of the sealing member 41 is the compressive deformation amount at the point P1 or more, a variation of the compressive deformation amount of the sealing member 41, which is caused depending on the variation of the sum of the compressive deformation amounts, is smaller than that in a case where the compressive deformation amount of the sealing member 41 is less than the compressive deformation amount at the point P1. For example, as illustrated in FIG. 7, the variation of the sum of the compressive deformation amounts is represented by V1. A variation V2 of the compressive deformation amount of the sealing member 41 in the case where the compressive deformation amount of the sealing member 41 is the compressive deformation amount at the point P1 or more is smaller than a variation V3 of the compressive deformation amount of the sealing member 41 in the case where the compressive deformation amount of the sealing member 41 is less than the compressive deformation amount at the point P1. This occurs because the proportion of the compressive deformation amount of the sealing member 41 in the sum of the compressive deformation amounts decreases over the point P1 and the proportion of the compressive deformation amount of the rubber washers 81 in the sum of the compressive deformation amounts increases over the point P1. In other words, the variation of the compressive deformation amount of the rubber washers 81 increases, as the variation of the compressive deformation amount of the sealing member 41, which is caused depending on the sum of the compressive deformation amount, decreases.

The variation of the compressive deformation amount of the sealing member 41 causes the sealing performance between the cover member 51 and the housing 20 to vary, and thus, the variation of the compressive deformation amount of the sealing member 41 is preferably reduced. On the other hand, the sealing performance is not required for the rubber washers 81, and thus, the rubber washers 81 are allowed to vary in the compressive deformation amount thereof, as compared with the sealing member 41.

The following will describe advantageous effects of the present embodiment.

(1) The sealing member 41 and the rubber washers 81 suppress transmission of vibrations of the housing 20 to the cover member 51, thereby reducing noise. In addition, the compressive deformation amount of the sealing member 41 is secured, thereby preventing the sealing performance between the housing 20 and the cover member 51 from decreasing.

When the compressive deformation amount of the rubber washers 81 becomes excessively large, the rubber washers 81 each hardly serve as a vibration absorbing material. It is suppressed that the compressive deformation amount of the rubber washers 81 becomes excessively large by making the stiffness of the rubber washers 81 larger than the stiffness of the sealing member 41, so that the rubber washers 81 are prevented from failing to serve as the vibration absorbing material.

(2) The fastening members 71 each include the bolt 72 and the collar 75. The collar 75 includes the flange 77. The bolt 72 and the collar 75 are separately provided, and thus, the flange 77 is prevented from rotating together with the bolt 72 when the external thread portion 74 is screwed into the corresponding insertion hole 33. This prevents each of the rubber washers 81 from being twisted by the rotation of the flange 77.

(3) The second defining surfaces 56 of the cover member 51 each surround a part of the corresponding rubber washer 81 in the radial direction thereof. The rubber washer 81 is squeezed by the flange 77. Here, when the rubber washer 81 is squeezed to expand in the radial direction of the rubber washer 81 excessively, the corresponding fastening member 71 may vary in an interference thereof. A part of the rubber washer 81 is surrounded in the radial direction of the rubber washer 81 by using the second defining surface 56, thereby suppressing the expansion of the rubber washer 81 in the radial direction.

The second defining surfaces 56 define the recess portions 57, respectively. The recess portions 57 are formed to prevent the heads 73 of the bolts 72 from protruding from the cover member 51. The second defining surfaces 56 used for defining the recess portions 57 each serve as the surrounding portion.

(4) The compressive deformation amount of the sealing member 41 is the compressive deformation amount at the point P1 or more. Accordingly, the variation of the compressive deformation amount of the sealing member 41 is reduced.

(5) The cover member 51 is disposed so as to face the outer surface 24, which is located in the direction perpendicular to the axial direction of the rotary shaft 13, of the outer surfaces of the accommodation portion 21. The length of the accommodation portion 21 in the axial direction of the rotary shaft 13 is longer than that of the accommodation portion 21 in the direction perpendicular to the axial direction of the rotary shaft 13. Thus, as compared with a case where the cover member 51 is disposed so as to face the outer surface, which is located in the axial direction of the rotary shaft 13, of the outer surfaces of the accommodation portion 21, the size of the cover member 51 becomes easily large.

As the size of the cover member 51 increases, the vibrations increase, thereby easily making noise larger. Accordingly, in the fluid machine 10 having a configuration in which noise is easily made larger, the noise is suitably reduced by using the sealing member 41 and the rubber washers 81.

The embodiment may be modified as follows. The present embodiment and the following modifications may be combined with each other as long as they do not technically contradict each other.

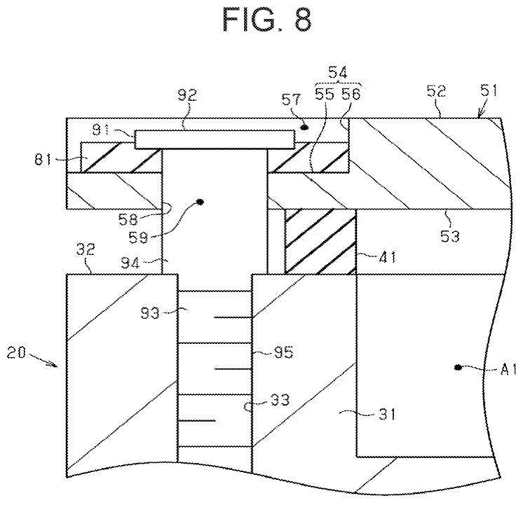

As illustrated in FIG. 8, the fastening members each may be a shoulder bolt 91. The shoulder bolt 91 has a head 92, a shank 95, an external thread portion 93, and a cylindrical portion 94. The cylindrical portion 94 is disposed between the head 92 and the shank 95. The external thread portion 93 is formed on an outer peripheral surface of the shank 95. A diameter of the cylindrical portion 94 is longer than that of the shank 95. It is impossible to insert the cylindrical portion 94 into the insertion hole 33. The shank 95 and the cylindrical portion 94 are inserted through the corresponding through hole 59. The cylindrical portion 94 is in contact with the outer surface 32 of the partition wall 31. The external thread portion 93 is screwed to the corresponding insertion hole 33. The rubber washer 81 is provided between the head 92 and the first defining surface 55. When the shoulder bolt 91 is used as the fastening member, the head 92 corresponds to the flange. The cylindrical portion 94 corresponds to the positioning portion.

The number of components when the shoulder bolts 91 are used as the fastening members is reduced as compared to that when the bolts 72 and the collars 75 are used as the fastening members.

The fastening members only need to be fastened to the housing 20 such that the cover member 51 is fixed to the housing 20. As an example of the fastening members, pins may be replaced with the bolts 72. Each pin has a head and a shank. The shank is inserted into the corresponding insertion hole 33. The pins are fixed to the housing 20 by any means. For example, the pins may be fixed by claws that are each formed at an end of the shank and hold the housing 20.

The bolt 72 may extend through the corresponding insertion hole 33 and be screwed into a nut.

The second defining surface 56 may be formed in a circular ring shape. That is, the second defining surface 56 need not be continuous with the peripheral edge of the cover member 51. In this case, the second defining surface 56 surrounds an entirety of the rubber washer 81 in the radial direction thereof.

The surrounding portion may protrude from the first surface 52 of the cover member 51 in the thickness direction of the cover member 51.

The cover member 51 need not include the surrounding portion. For example, the through hole defining surfaces 58 extend from the first surface 52 to the second surface 53 in the cover member 51, and the rubber washers 81 may be disposed between the flanges 77 and the first surface 52.

The sealing member 41 need not have the protruding portions 43. That is, the sealing member 41 may be only formed of the main body 42. In this case, there may be no point in the compressive deformation amount of the sealing member 41 at which the change amount of the load relative to the change amount of the compressive deformation amount is changed.

The compressive deformation amount of the sealing member 41 may be less than the compressive deformation amount at the point P1.

The protruding portion 43 may protrude from the main body 42 on only one side in the axial direction of the sealing member 41.

The housing 20 and the cover member 51 may be changed in any shape as long as the accommodation chamber A1 is defined by them. For example, the cover member 51 may have the partition wall 31.

The cover member 51 may be disposed so as to face the outer surface, which is located in the axial direction of the rotary shaft 13, of the outer surfaces of the accommodation portion 21. In this case, the accommodation chamber A1 is defined between the cover member 51 and the outer surface, which is located in the axial direction of the rotary shaft 13, of the outer surfaces of the accommodation portion 21.

The fluid machine 10 may be an electric pump including a pump unit that is driven by the electric motor 12.

### REFERENCE SIGNS LIST

A1 accommodation chamber
P1 point
10 fluid machine
12 electric motor
14 inverter
20 housing
33 insertion hole
41 sealing member
51 cover member
56 second defining surface serving as surrounding portion
70, 95 shank
71 fastening member
72 bolt
74, 93 external thread portion
75 collar
76 positioning portion
77 flange
81 rubber washer
91 shoulder bolt
92 head corresponding to flange
94 cylindrical portion corresponding to positioning portion

1. A fluid machine comprising:
an electric motor;
an inverter configured to drive the electric motor;
a housing in which the electric motor is accommodated;
a cover member that is fixed to the housing and defines an accommodation chamber in which the inverter is accommodated;
a sealing member that is disposed between the cover member and the housing and makes a seal for the accommodation chamber; and
a fastening member that extends through the cover member and is fastened to the housing to fix the cover member to the housing, wherein
the housing has an insertion hole,
the fastening member has:
a shank inserted into the insertion hole;
a flange applying a fastening force to the cover member through a rubber washer; and
a positioning portion that is in contact with the housing to define positions of the shank and the flange relative to the housing,
the cover member is supported on the housing such that the cover member is held between the rubber washer and the sealing member that are elastically deformed, and
stiffness of the rubber washer is greater than stiffness of the sealing member.

2. The fluid machine according to claim 1, wherein
the fastening member has:
a bolt; and
a collar into which the bolt is inserted,
the bolt has:
the shank; and
an external thread portion screwed into the insertion hole, and
the collar has:
the positioning portion; and
the flange.

3. The fluid machine according to claim 1, wherein
the fastening member is a shoulder bolt,
the shoulder bolt has:
a head;
the shank;
an external thread portion screwed into the insertion hole; and
a cylindrical portion that is disposed between the head and the shank and has a diameter larger than a diameter of the shank,
the head corresponds to the flange, and
the cylindrical portion corresponds to the positioning portion.

4. The fluid machine according to claim 1, wherein
the cover member has a surrounding portion that surrounds at least a part of the rubber washer in a radial direction of the rubber washer.

5. The fluid machine according to claim 1, wherein
in a compressive deformation amount of the sealing member, a change amount of a load of the sealing member relative to a change amount of the compressive deformation amount is changed at a point,
the change amount of the load relative to the change amount of the compressive deformation amount in a case where the compressive deformation amount of the sealing member is a compressive deformation amount at the point or more is larger than the change amount of the load relative to the change amount of the compressive deformation amount in a case where the compressive deformation amount of the sealing member is less than the compressive deformation amount at the point, and
the compressive deformation amount of the sealing member is the compressive deformation amount at the point or more.
